(19) United States
(12) Patent Application Publication
(10) Pub. No.: US 2018/0154901 A1
(43) Pub. Date: Jun. 7, 2018

(54) METHOD AND SYSTEM FOR LOCALIZING A VEHICLE

(71) Applicant: Robert Bosch GmbH, Stuttgart (DE)

(72) Inventors: Carsten Hasberg, Ilsfeld-Auenstein (DE); Christoph Schroeder, Sunnyvale, CA (US); Danny Hiendriana, Ludwigsburg (DE); Oliver Pink, Ditzingen (DE); Philipp Rasp, Wannweil (DE)

(21) Appl. No.: 15/813,309

(22) Filed: Nov. 15, 2017

(30) Foreign Application Priority Data
Dec. 7, 2016 (DE) 102016224329.2

(51) Int. Cl. B60W 40/04; G01S 13/89; G01S 13/86

(52) U.S. Cl. CPC B60W 40/04; G01S 13/89; B60W 2420/403; B60W 2550/30; B60W 2420/52; G01S 13/86

(57) ABSTRACT

A method and an associated system for vehicle localization are described. The system includes a first sensor unit for determining a relative movement of the vehicle in relation to at least one feature in the vehicle surroundings and a second sensor unit for detecting radar data of the vehicle surroundings. The system also includes a memory for storing a digital map, a localization unit, which is configured, for ascertaining a preliminary position indication, to localize the vehicle in the digital map based on the relative movement determined by the first sensor unit, and a position determination unit, which is configured to compare the radar data detected by the second sensor unit with the digital map while taking the preliminary position indication into account, and to determine a position of the vehicle based on the comparison.

### CROSS REFERENCE

The present application claims the benefit under 35 U.S.C. § 119 of German Patent Application No. DE 102016224329.2 filed on Dec. 7, 2016, which is expressly incorporated herein by reference in its entirety.

### FIELD

The present invention relates to a method and a system for localizing a vehicle. The present invention relates, in particular, to a method and a system for localizing a vehicle using radar.

### BACKGROUND INFORMATION

Conventional driver assistance systems are increasingly used for controlling vehicles. In addition, there will be a wide variety of highly automated or fully automated driver assistance functions in the future, in which the vehicle is automatically controlled without permanent monitoring by the driver. Important above all for highly automated and fully automated driving is the capability of the vehicle or the capability of the corresponding function to be able to perform an accurate and instantaneous localization of the vehicle at any time. This means, there is the requirement of having accurate information at any time as to where the vehicle is presently located.

A method for a radar-based localization is described in U.S. Patent App. Pub. No. 2013/103298, in which an approximate GPS-based localization is refined by carrying out a comparison between data from a radar and recorded data from a geo-referenced data base.

However, GPS position information may be erroneous, for example, due to a multipath propagation of the GPS signals or due to the occurrence of GPS jamming or GPS spoofing, i.e., the use of jammers.

Hence, there is a need to create a system and a method for localizing a vehicle, which enables an accurate position determination preferably free of external interferences.

### SUMMARY

In accordance with the present invention, a system and a method for localizing a vehicle and a correspondingly equipped vehicle are provided.

Preferred refinements of the present invention are described herein.

According to one aspect of the present invention, a method is provided for localizing a vehicle. In this method, radar measured values with respect to the instantaneous vehicle surroundings are obtained and a relative movement of the vehicle in relation to at least one feature present in the vehicle surroundings is measured. Furthermore, the vehicle is localized in a digital map based on the measured relative movement, in order to ascertain in this way a preliminary position indication for the position determination of the vehicle. The radar measured values obtained are further compared with the digital map, this taking place while the ascertained preliminary position indication is taken into account. Finally, a position of the vehicle is determined based on the comparison.

According to another aspect of the present invention, a vehicle localization system is provided, which includes a first sensor unit and a second sensor unit. The first sensor unit is used to determine a relative movement of the vehicle in relation to at least one feature in the vehicle surroundings, and the second sensor unit is used to detect radar data of the vehicle surroundings. The system further includes a memory for storing a digital map, a localization unit and a position determination unit. The localization unit is configured to localize the vehicle in the digital map for ascertaining a preliminary position indication based on the relative movement determined by the first sensor unit, and the position determination unit is configured to compare the radar data detected by the second sensor unit with the digital map, while taking the preliminary position indication into account, and to determine a position of the vehicle based on the comparison.

According to still another aspect, a vehicle, in particular, an autonomously driving vehicle, is provided. A central control unit of the vehicle includes the system for vehicle localization according to the present invention and is configured in such a way that the method according to the present invention may be applied for localizing the vehicle.

The aspects of the present invention enable a robust and highly accurate localization or self-localization. A localization may take place, in particular, without the use of GPS and/or without the effects of interferences possible in connection with a GPS localization. Thus, an autonomy may be achieved with respect to GPS interferences. Both the global position of a vehicle as well as an exact localization in relation to the immediate surroundings of the vehicle may therefore by ascertained in a reliable manner, which may, for example, be advantageously applied for the use of autonomous driving functions or for driver assistance systems. As a result, the robustness of the highly accurate vehicle localization may be enhanced compared to the related art. This is facilitated, in particular, by the interaction of a radar measurement on the one hand and a measurement of the relative movement of the vehicle on the other hand.

According to exemplary specific embodiments of the present invention, the radar measured values are obtained by on-board radar sensors. Alternatively or in addition, the radar measured values may be obtained by off-board radar sensors, which are situated in the immediate surroundings of the vehicle, or which are installed in another vehicle.

In this way, it is possible, in principal to measure a very accurate image of the vehicle surroundings, which is enabled, in particular, by the meanwhile achieved high accuracy of radar. The accuracy in this case may be further optimized by the use of multiple radar sensors on the vehicle or in the surroundings.

According to preferred specific embodiments, the vehicle is in communication with external sensors, in particular, radar sensors, via a vehicle-to-X communication.

Furthermore, measurements in the form of a local radar map previously carried out and stored in a memory may be provided. The obtaining of radar measured values in part from a local radar map is suitable according to the method, in particular, with respect to immobile objects of the vehicle surroundings. The local radar map may also be supplemented or corrected or updated by instantaneous radar measured values. The local radar map in this case may be stored on a central server system, which is situated remotely from the vehicle, in the vehicle or in a roadside object of the vehicle surroundings.

The digital map, which is used for localizing the vehicle based on the measured relative movement, may be stored in a database, which may include, in particular, radar data.

The digital map is preferably a highly accurate radar map, which includes, in particular, the local radar map of the vehicle surroundings.

According to one specific embodiment of the present invention, the digital map is updated as part of the comparison, in which the radar measured values are compared with the present digital map. The data stored in the database are not limited to radar measured values, however, but may also be of another suitable source.

According to one preferred specific embodiment, a cloud access may also be enabled via the database.

The relative movement may be measured, in particular, with the aid of one or of multiple inertial sensors. A visual odometry system may also be used. The odometry system may include one or multiple cameras, which are preferably situated on the vehicle itself to be localized. It is also conceivable, however, that alternatively or in addition, an ultrasonic sensor system, a LIDAR system or another type of suitable sensor system is used.

Because the vehicle is localized in the digital map or self-localized based on the measured relative movement so that a preliminary position indication is ascertained, an approximate and/or a global vehicle position may be initially ascertained, which may then be refined based on the comparison and consideration of the instantaneous radar data.

According to one specific embodiment, the digital map may be updated based on the measured data, which are obtained during the measurement of the relative movement.

Furthermore, the digital map may preferably include a surroundings model relating to the instantaneous vehicle surroundings.

The digital map may be managed by a central server system, which has a communication link to the vehicle, so that the digital map may be transmitted at least partly to the vehicle. In this case, the surroundings model may be used to describe the features of the vehicle surroundings.

According to one preferred specific embodiment of the present invention, a probabilistic sensor model is used to measure the relative movement, the present invention not being limited thereto, however.

A probabilistic surroundings model may be similarly used for the digital map.

Furthermore, according to one preferred specific embodiment of the present invention, the localization may be carried out using a probabilistic localization method.

The digital map may correspond to data sets, which describe a network of features. In this case, the features used for the vehicle localization are not limited in any way. Instead, any feature or object of the surroundings suitable for detecting a relative movement may be considered. Objects of the vehicle surroundings preferably created or influenced by humans may also be considered. The description of the features to be measured, as an example, may be based, in particular, on a model, for which a Bayesian statistic is applied, so that a so-called “Manhattan scenery” may be modelled. The measurement of the relative movement may also be evaluated with the aid of a filter such as, for example, a Kalman filter.

Thus, according to the aspects of the present invention, a two-step operating localization system may be advantageously implemented. Thus, a first phase may be considered as an initialization phase, in which the vehicle is localized approximately in the digital map based on the measurement of the relative movement. The digital map in this case may preferably be a radar map. Furthermore, a second phase may be carried out as a localization phase, i.e., a position determination phase, in which a comparison between the digital map and the measured radar data is carried out for a more accurate position determination. In the process, the ascertainment of the position may be improved in the second phase as a result of the comparison of the radar data of the highly accurate map with the detected radar data of the sensors.

The localization unit of the system, which may carry out the first phase of the method, and the position determination unit, which may carry out the second phase of the method, may be situated in a control unit of the system. In this configuration, the control unit according to certain specific embodiments of the present invention may include a central control unit of the vehicle. The control unit may also include the central server system, which has a communication link to the vehicle.

### BRIEF DESCRIPTION OF THE DRAWINGS

Preferred specific embodiments of the present invention are explained in greater detail below with reference to the figures.

FIG. 1 schematically shows a block diagram of a system for localizing a vehicle according to one specific embodiment of the present invention.

FIG. 2 shows a flow chart of a method for localizing a vehicle according to one specific embodiment of the present invention.

### DETAILED DESCRIPTION OF THE EXAMPLE EMBODIMENTS

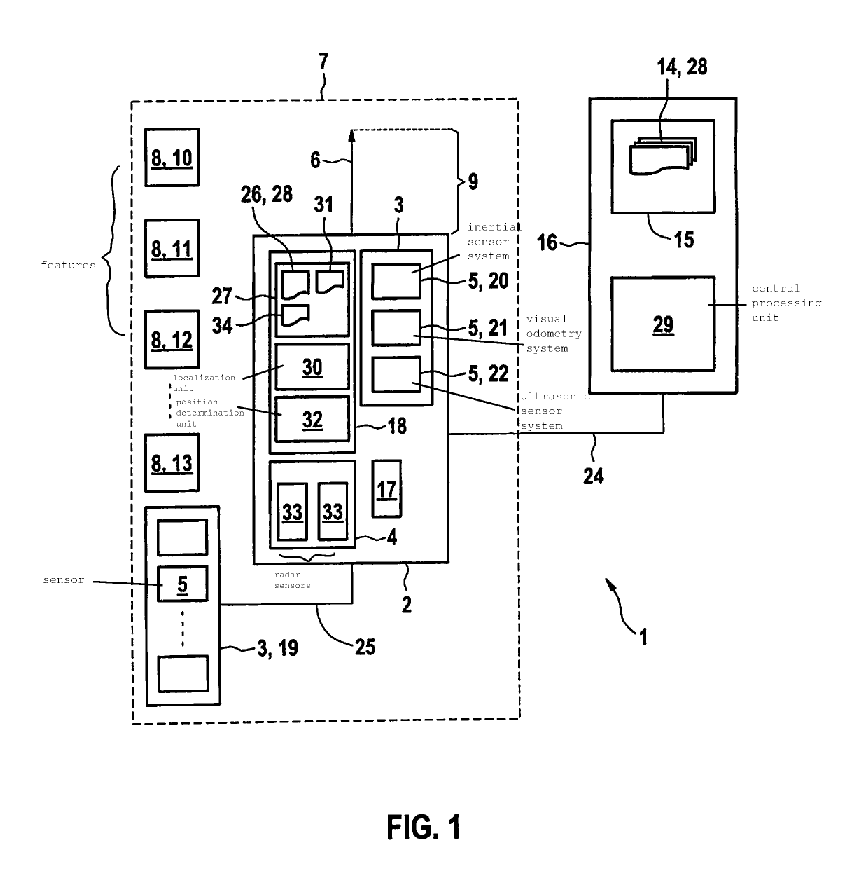

FIG. 1 schematically shows a block diagram of a system 1 for localizing a vehicle 2, according to one specific embodiment of the present invention. System 1 includes a first sensor unit 3 and a second sensor unit 4. First sensor unit 3 has a sensor system including multiple sensors 5. Sensors 5 are provided for determining a relative movement 6 of vehicle 2 in relation to vehicle surroundings 7 or in relation to features 8 of vehicle surroundings 7. Vehicle surroundings 7 may be the immediate surroundings of vehicle 2, which are detected by sensors 5, each suitable feature 8, which is located in any direction of the 4_{TT} solid angle around vehicle 2 or which is located in an arbitrary direction of the 360° degree surroundings of vehicle 2 being capable of being detected. In order to more accurately explain in the drawing relative movement 6 to be measured, a distance 9 is also shown between a front edge of vehicle 2 and a particular height of surroundings 7, distance 9 extending along the direction of relative movement 6 and changing continually with the progressive forward movement of vehicle 2.

By measuring relative movement 6, it is initially possible to at least approximately localize vehicle 2. For this purpose, features 8 of the vehicle surroundings are detected by sensors 5. Features 8 are not limited to a particular species of objects, structural features, or properties. Instead, any feature 8 or object suitable for detecting a relative movement 6 may be used. In addition, the number of features 8 measured in parallel is, in principal, arbitrary and is suitably selected and filtered depending on the number of measurement resources and on the process computing effort. For example, it is conceivable that feature 10 shown in the highly schematic depiction of FIG. 1 represents a horizontal edge or a vertical edge of a particular building. However, features 8 may also be arbitrary other objects, in particular, objects influenced or created by humans. For example, feature 11 may be a traffic sign, feature 12 may represent one or multiple road markings or reflector posts, and feature 13 may be a road intersection.

According to the specific embodiment shown here, a digital map 14 is stored as a database in memory 15 of a remote central server system 16. Furthermore, vehicle 2 is equipped with a transceiver unit 17, with the aid of which vehicle 2 has a communication link 24 with server system 15.

System 1 is controlled by a control unit 18, which is implemented here as a function of the central control unit of vehicle 2. Control unit 18 activates sensors 5 of first sensor unit 3 as well as second sensor unit 4 situated in the vehicle. Furthermore, according to the specific embodiment explained here, control unit 18 also includes components (not shown) outside vehicle 2 for activating part 19 of first sensor unit 3, which is situated outside vehicle 2. Although according to numerous specific embodiments, only on-board sensors 5 of vehicle 2 are used for measuring relative movement 6, here, off-board sensors 19 are also involved, which are situated in a roadside object or in another vehicle, the data being transmitted between the external sensors and vehicle 2 for fusing with the aid of vehicle-to-x communication or vehicle-to-vehicle communication 25.

Sensors 5 include an inertial sensor system 20, which includes multiple inertial sensors, not individually shown here for the sake of simplicity of the representation. Sensors 5 also include a visual odometry system 21 and/or a suitable system such as, for example, an ultrasonic sensor system 22 or a LIDAR system. According to one variant, sensors 5 may also include radar sensors.

Relevant parts of digital map 14 are transmitted via communication link 24 to the vehicle and may be stored there in memory 27 of central control unit 18, in particular, as local map 26. Digital map 14 is updated or corrected at regular intervals via a cloud. This may take place, in particular, by updating initially local map 26, which is then transmitted back to central server 16 via communication link 24. This type of updating of local map 26 is based, in particular, on measurements of sensor units 3, 4 of vehicle 2. The term “digital map” 28 below, depending on the context, means local map 26, digital map 14 stored on server 16, or both. Map 28 may exhibit a high accuracy due to the updates which, in general, may take place through host vehicle 2, through other vehicles or through roadside infrastructure.

According to the specific embodiment shown here, digital map 28 includes data sets, which correspond to a network of virtual features, which reproduce the spatial properties of at least a part of features 8 of the vehicle surroundings. According to one preferred variant, radar data are stored for this purpose in digital map 28. For the localization to be carried out, suitable models are applied, which are calculated by central processing unit 29 of central server system 16 and/or by central control unit 18. However, vehicle 2 is not absolutely reliant on server system 16 and is therefore largely independent of a permanent communication link 24. This is a result of the fact, as previously mentioned, that relevant parts 26 of digital map 28 are stored in vehicle 2.

Central control unit 18 includes a localization unit 30, which is linked to sensors 5 and memory 27. Localization unit 30 activates sensors 5, so that values may be obtained for calculating a course of relative movement 6 of vehicle 2. For this purpose, a probabilistic sensor model is preferably provided as a basis. Vehicle 2 is localized in digital map 28 based on measured relative movement 6, so that a preliminary position indication 31 is available.

In descriptive terms, an algorithm is applied in such case, by which, for example, a particular course of relative movement 6 is compared with a suitable potential course of the vehicle route based on the digital map, until a matching result is found, by which position 31 of vehicle 2 may be approximately calculated. By considering digital map 28 in combination with measured relative movement 6, it is possible to also globally determine the position of vehicle 2. Preliminary position indication 31 is improved by the use of second sensor unit 32.

Central control unit 18 also includes a position determination unit 32. Position determination unit 32 activates sensor unit 4, sensor unit 4 including a plurality of radar sensors 33. With radar sensors 33, it is possible to measure an accurate position 34 of vehicle 2. For this purpose, the detected sensor data of radar sensors 33 are again compared with digital map 28, i.e., with the highly accurate radar map, an approximated position on map 28 already being known. Thus, position 32 is precisely determined by the radar measurements.

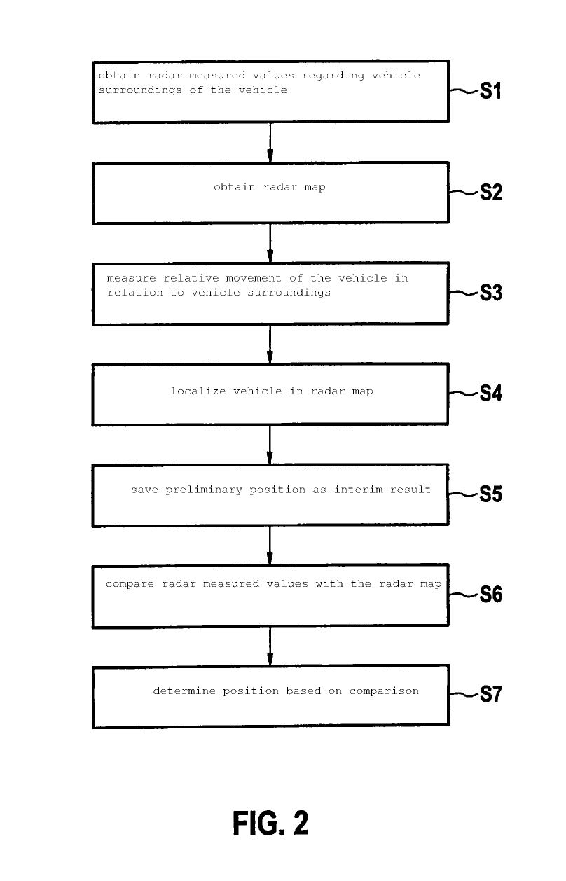

FIG. 2 shows a method for localizing a vehicle according to one specific embodiment of the present invention. In step S1, radar measured values regarding the vehicle surroundings of the vehicle are obtained. In step S2 a radar map is obtained and stored in a memory. The radar map in this case corresponds to a digital map, which describes the surroundings of the vehicle. In step S3, a relative movement of the vehicle in relation to the vehicle surroundings is measured, for which purpose a first sensor unit of the vehicle is used, which is able to carry out odometry measurements. In step S4, the vehicle is localized in the radar map based on the measured relative movement and a preliminary position indication is ascertained, which describes approximately the position of the vehicle. In step S5, the preliminary position indication is saved as an interim result. In step S6, the radar measured values obtained in step S1 are compared with the radar map. In step S7, a position of the vehicle is determined based on the comparison from step S6, in order to improve in this way the preliminary position indication.

What is claimed is:

1. A method for localizing a vehicle, comprising:
obtaining radar measured values with respect to the vehicle surroundings;
measuring a relative movement of the vehicle in relation to at least one feature present in the vehicle surroundings;
localizing the vehicle in a digital map based on the measured relative movement, for ascertaining a preliminary position indication;
comparing the obtained radar measured values with the digital map while taking the preliminary position indication into account; and
determining a position of the vehicle based on the comparison.

2. The method as recited in claim 1, wherein the radar measured values are obtained by at least one of on-board radar sensors and off-board radar sensors situated in particular in the vehicle surroundings.

3. The method as recited in claim 1, wherein the digital map is based on radar map data in a database.

4. The method as recited in claim 1, wherein the digital map is updated based on the obtained radar measured values during the comparison of the obtained radar measured values with the digital map.

5. The method as recited in claim 1, wherein the relative movement is measured with the aid of at least one of: (i) at least one inertial sensors, and (ii) a visual odometry system which includes at least one camera.

6. The method as recited in claim 1, wherein the digital map is updated based on measured data obtained during the measurement of the relative movement.

7. The method as recited in claim 1, wherein the digital map includes a surroundings model with respect to the instantaneous vehicle surroundings and is managed by a central server system, which has a communication link to the vehicle, the surroundings model being used to describe features of the vehicle surroundings.

8. The method as recited in claim 1, wherein at least one of a probabilistic sensor model and a probabilistic surroundings model, is used to measure the relative movement.

9. The method as recited in claim 1, wherein the localization is carried out using a probabilistic localization method.

10. A system for localizing a vehicle, comprising:
a first sensor unit for determining a relative movement of the vehicle in relation to at least one feature in the vehicle surroundings;
a second sensor unit for detecting radar data of the vehicle surroundings;
a memory for storing a digital map;
a localization unit which is configured to localize the vehicle in the digital map for ascertaining a preliminary position indication based on the relative movement determined by the first sensor unit; and
a position determination unit configured to compare the radar data detected by the second sensor unit with the digital map while taking the preliminary position indication into account, and to determine a position of the vehicle based on the comparison.

11. The system as recited in claim 10, wherein the first sensor unit includes at least one of an inertial sensor system, a visual odometry system, an ultrasonic sensor system, and a LIDAR system, and the second sensor unit includes at least one on-board or off-board radar sensor.

12. The system as recited in claim 10, wherein the memory is situated in a central server system, to which the vehicle has a communication link, so that the digital map may be at least partly transmitted to the vehicle.

13. The system as recited in claim 12, wherein the localization unit and the position determination unit are situated in a control unit, the control unit including at least one of a central control unit of the vehicle and the central server system.

14. A autonomously driving vehicle, which includes a central control unit, and a system for vehicle localization, the system comprising:
a first sensor unit for determining a relative movement of the vehicle in relation to at least one feature in the vehicle surroundings;
a second sensor unit for detecting radar data of the vehicle surroundings;
a memory for storing a digital map;
a localization unit which is configured to localize the vehicle in the digital map for ascertaining a preliminary position indication based on the relative movement determined by the first sensor unit; and
a position determination unit configured to compare the radar data detected by the second sensor unit with the digital map while taking the preliminary position indication into account, and to determine a position of the vehicle based on the comparison.
